(19) United States
(12) Patent Application Publication
(10) Pub. No.: US 2024/0066442 A1
(43) Pub. Date: Feb. 29, 2024

(54) REPLACEMENT FAUCET FILTER FOR FAUCET MOUNTED FILTER UNIT

(71) Applicant: INSPIRED VENTURES LLC, Portsmouth, NH (US)

(72) Inventors: Scott Andrew CHAUDOIN, Portsmouth, NH (US); James Edward SHEPARD, Marblehead, MA (US); Brendan Boyd CRAWFORD, Roslindale, MA (US)

(21) Appl. No.: 18/237,665

(22) Filed: Aug. 24, 2023

Related U.S. Application Data
(60) Provisional application No. 63/400,896, filed on Aug. 25, 2022.

(51) Int. Cl. B01D 29/33; B01D 29/58; B01D 35/04; B01D 35/30; B01D 39/20

(52) U.S. Cl. CPC B01D 29/33; B01D 29/58; B01D 35/04; B01D 35/30; B01D 39/2055; B01D 2201/295

(57) ABSTRACT

A replacement filter cartridge for a faucet mounted water filter includes a hollow filter body having an open upper portion having an upper annular edge and partially enclosed bottom portion with a fluid egress orifice therein. The upper annular edge includes a series of castellations. A filter element is disposed within the hollow filter body, and a filter element cover is configured to cover and secure the filter element, said filter element cover includes depressions in an outer peripheral edge. The depressions in the outer peripheral edge form openings between the depressions and an inner peripheral surface of the filter body, such that water can flow into the openings, through the filter element, and out of the filter housing through the fluid egress orifice.

### CROSS-REFERENCE TO RELATED APPLICATIONS

This application claims priority to U.S. Provisional Patent Application No. 63/400,896, filed on Aug. 25, 2022. The contents of this application is hereby incorporated by reference.

### BACKGROUND

### Field of Invention

Conventional replacement faucet filters are manufactured with a carbon block inside of a plastic body. Examples of such replacement faucet filters are the PUR™ SKU RF-9999 and PUR™ SKU RF-3375.

### Description of Related Art

An example of a conventional replacement faucet filter and a faucet filter housing is shown in FIG. 1. Replacement filter 101 is configured to be inserted into a cavity formed by faucet filter base 103 and faucet filter cap 102. Conventional replacement faucet filter bodies are designed with a number of physical characteristics that increase the cost and complexity. These physical characteristics require additional material, such as plastic, and complex tools and molding or other fabrication procedures which contribute to higher costs to manufacture. Specifically, some of the physical characteristics are:
1. A plastic top cap with a molded plastic tab and a molded water input, as illustrated in FIG. 2.
2. Molded ridges 301 on the side body of the filter housing designed to hold an O-ring, as illustrated in FIG. 3.
3. Two extended molded rings 401 and 402 at the bottom of the filter, as illustrated in FIG. 4.

An objective of the inventive replacement faucet filter is to provide a replacement faucet filter with less plastic, and simplified tooling that can result in significantly lower manufacturing costs.

### SUMMARY

In certain embodiments, the invention can include a replacement filter cartridge for a faucet mounted water filter; the replacement filter cartridge can comprise a hollow filter body having an open upper portion having an annular edge and a partially enclosed bottom portion with a fluid egress aperture or orifice therein; the upper annular edge can have a series of castellations. A filter element is disposed within the hollow replacement faucet filter body. A filter element cover is configured to cover and secure the filter element; the filter element cover includes depressions or notches in an outer peripheral edge. The depressions or notches form openings between the depressions and an inner peripheral surface of the filter body, such that water can flow into the openings, through the filter element, and out of the filter body through the fluid egress orifice.

### BRIEF DESCRIPTION OF THE DRAWINGS

FIG. 1 illustrates a conventional replacement faucet filter and standard faucet filter housing;

FIG. 2 illustrates a plastic top cap of a conventional replacement faucet filter;

FIG. 3 is a side view of a conventional replacement faucet filter;

FIG. 4 is a bottom view of a conventional replacement faucet filter;

FIG. 5 is an expanded view of a filter according to certain embodiments of the invention;

FIG. 6 is a perspective view according to certain embodiments of the invention;

FIG. 7 illustrates an embodiment of the invention and a standard faucet filter housing;

FIG. 8 illustrates water flow according to embodiments of the invention;

FIG. 9 is a top view according to embodiments of the invention;

FIG. 10 is a bottom view of certain embodiments of the invention;

FIG. 11A is a side view of the bottom portion shown in FIG. 10;

FIG. 11B is a cross-section of the side view of FIG. 11(a).

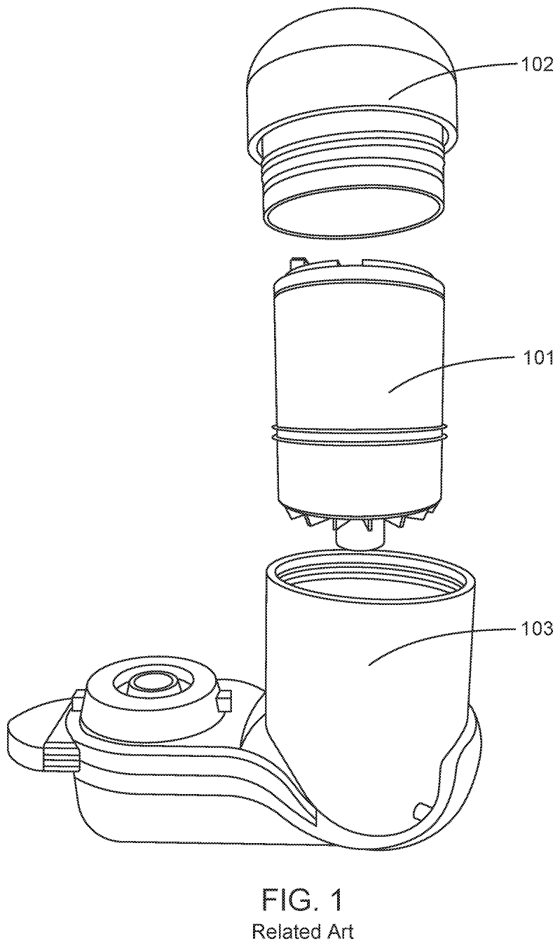

### DETAILED DESCRIPTION

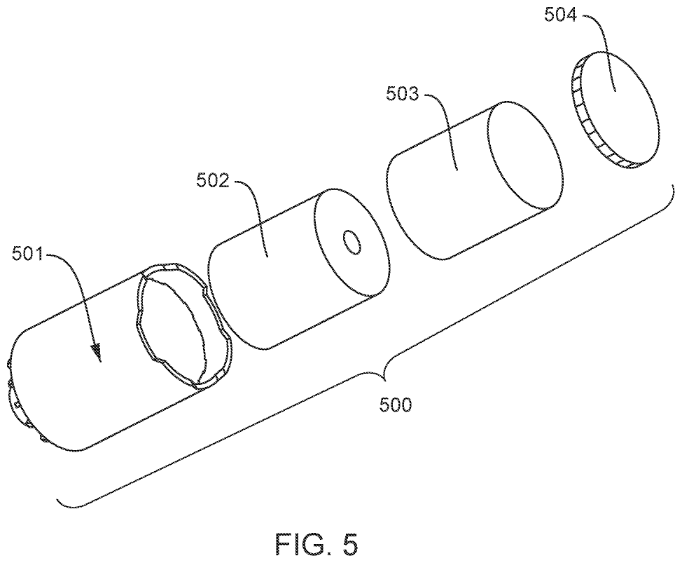

Embodiments of the invention relate to the replacement filter body and cover that holds a filter element that is used to filter water in a faucet filter unit that attaches to a faucet, as illustrated for example in FIG. 5.

The body can be molded or formed of a suitable material such as plastic, resin, aluminum, etc. The filter element can be made of a suitable material such as a carbon block, paper element, composite element, etc. Embodiments of the invention have numerous functional characteristics that can lead to a less costly and more efficient filter to manufacture compared to related or conventional art.

Referring to FIG. 5, embodiments of the invention can include replacement filter 500, which includes replacement filter body 501, replacement filter element 502, wrap 503, and element cover 504. Replacement faucet filter body 501 can be fabricated by molding, extrusion, or other suitable process, using materials such as plastic, resin, metal, etc. Appropriate measures need to be taken to eliminate issues of corrosion, in the event that corrodible materials such as metal are used. Filter element 502 can be a carbon block, paper element, or other suitable material depending upon the type of filtration that is desired. Wrap 503 can surround filter element 502, to provide prefiltering or additional filtration capabilities. Wrap 503 can be made of fabric, paper, foam, screening, or other appropriate materials.

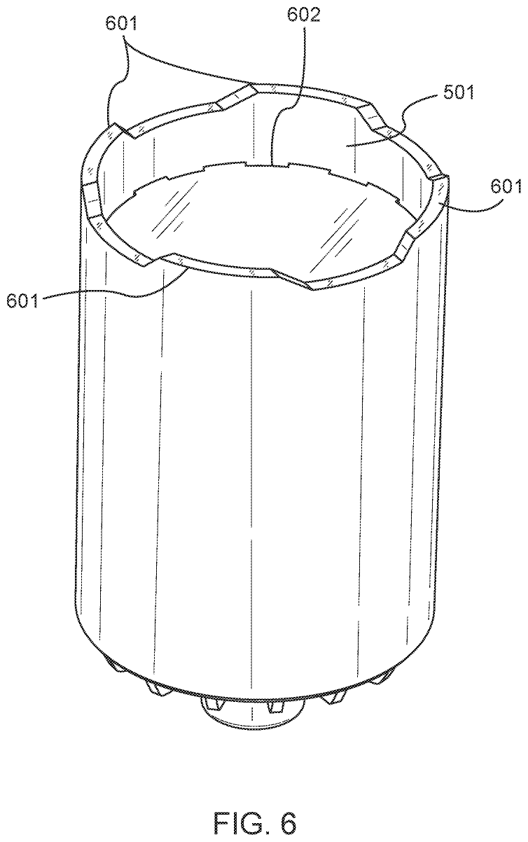

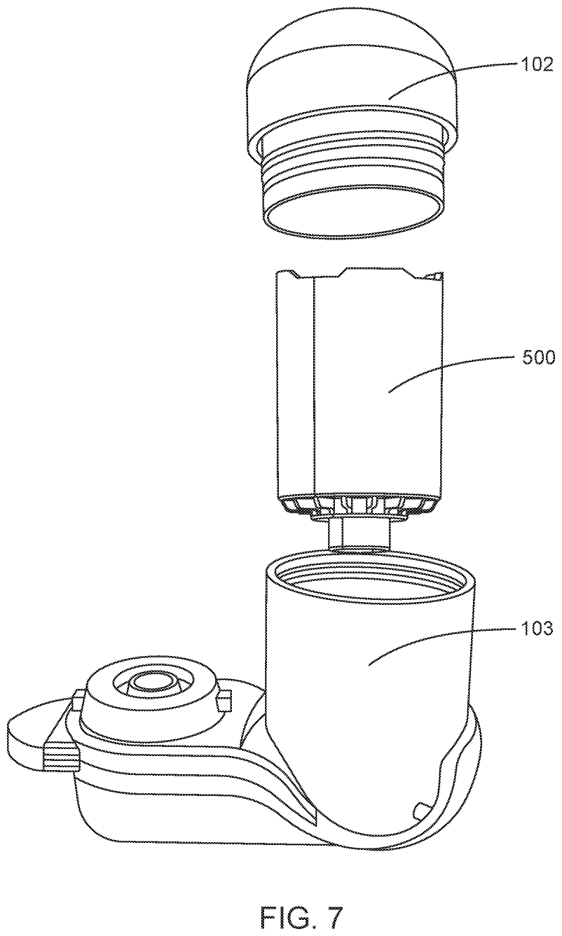

Element cover 504 include a series of depressions or notches in the outer peripheral edge thereof. When installed in the filter body 501, these notches or depressions form openings 602 (see FIG. 6).

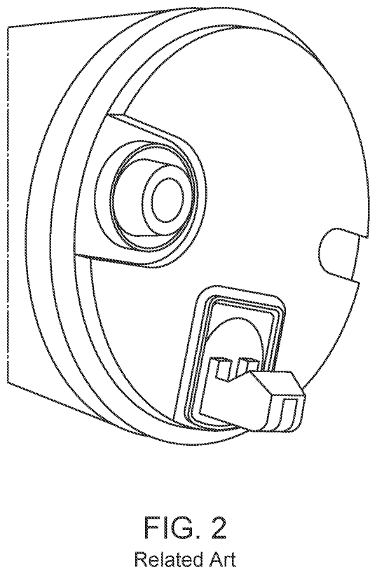

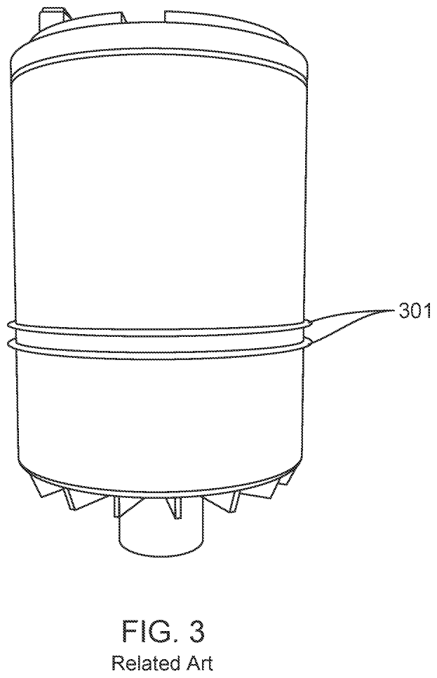

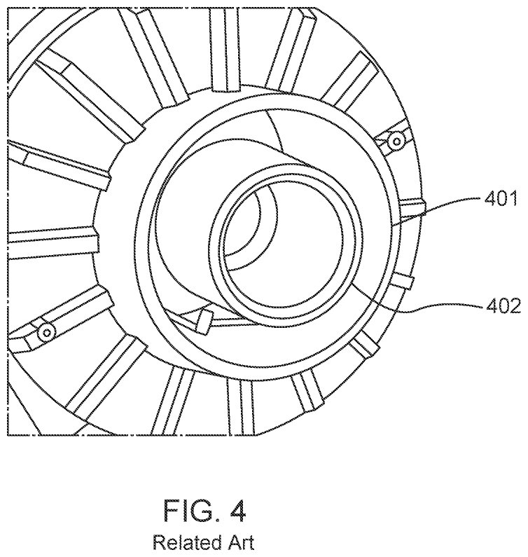

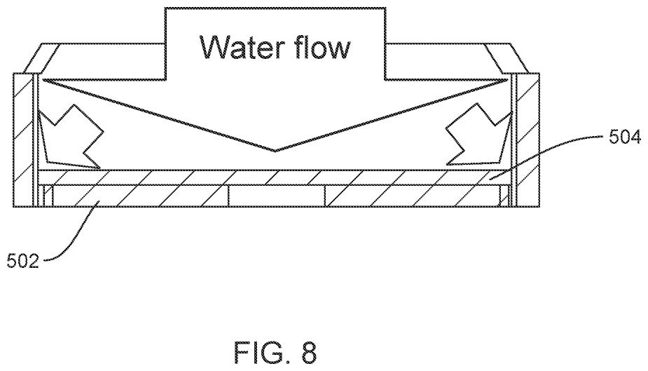

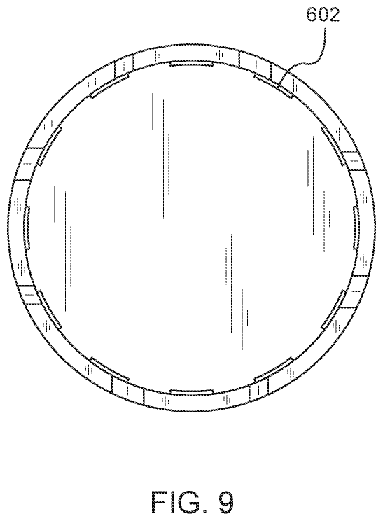

Unlike the related art shown in FIG. 2, here is no top cap on the plastic filter body of the invention, as illustrated in FIG. 6. Replacement faucet filter body 501 includes an upper annular edge which has a plurality of projections or castellations 601. When installed in the faucet filter housing, upper edges of the castellations engage a tab on an inner upper surface of faucet filter cap 102. As a result of this configuration, water flows directly from the faucet filter unit onto element cover 504, through openings 602, and into and through filter element 502. See FIG. 8. The inventor determined that this configuration provided efficient and effective filtering of water, without the additional manufacturing complexity of the additional top cap because filter element cover 504 allows the unfiltered water to flow through openings 602 and onto and through the wrap and the filter element where the filtration occurs. See FIGS. 8 and 9.

The side wall of the filter housing wall have been designed, with castellations 601, so they touch and engage the inside of the cap of the faucet filter unit and is shaped so that as the cap of the faucet filter unit is screwed on to the base of the unit, the replacement filter and the castellations engage with the faucet filter cap 102 as it is being screwed on to the faucet filter base 103 and as a result the replacement faucet filter will be pushed down and into its proper place in the faucet filter base. This configuration, therefore, helps eliminate the need for a top cap as used in conventional replacement filter. The function of the extended sides and castellations is to seat an o-ring located at the bottom of the faucet filter base (not shown) properly upon installation into the faucet filter housing. The raised areas of castellations 601 engage internal housing features of faucet filter cap 102 to ensure that filter 500 and hence the o-ring is rotated and seated. The extended side walls of filter body 501 afford a greater and more convenient area for the user to grab on to and hold during replacement filter installation than the prior art.

As shown in FIG. 6, certain embodiments enable the replacement filter to be manufactured without ridges on the side of the replacement filter housing 501. The inventors determined that the ridges 301 and the peripheral O-ring were not needed to enable the filter to channel and filter water effectively with conventional faucet filtration systems. This reduces manufacturing cost and complexity.

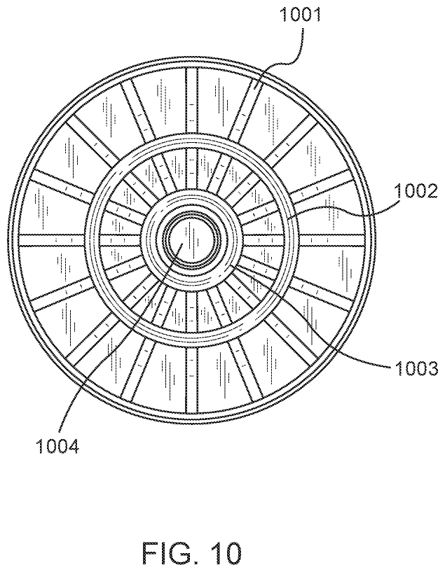

FIG. 10 is a bottom view according to certain embodiments of the invention. The bottom portion can include radial structural ribs 1001, shortened structural ring 1002, water egress orifice 1004, and outlet port which also acts as an extended structural ring 1003 surrounding water egress orifice 1004 and configured to engage the faucet filter housing.

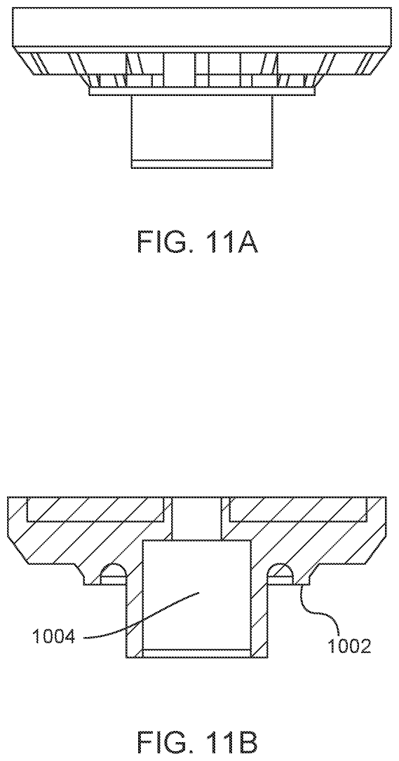

As illustrated in FIGS. 10, 11A and 11B, embodiments of the invention enable the filter to be manufactured with a single shortened circular structural ring 1002 and extended structural ring 1003 at the bottom, while enabling a secure and leak-proof fit. The conventional replacement filter uses two extended circular rings to enable proper structural support under pressure while also seating and sealing in the faucet filter base. The inventors determined that the inventive combination of features as described herein enable effective alignment and sealing with a shortened circular structural ring, thereby reducing manufacturing costs and complexity. Referring to FIG. 11B, orifice 1004 can be seen. It accommodates the o-ring in the faucet filter base.

The invention provides for a less expensive filter housing as it requires less material and uses a less expensing tooling and manufacturing process. It also allows for a replacement faucet filter that is more environmentally friendly.

1. A replacement faucet filter cartridge for a faucet mounted water filter, said replacement filter cartridge comprising:
a hollow filter body having an open upper portion having an annular edge and a partially enclosed bottom portion with a fluid egress orifice therein, the upper annular edge having a series of castellations;
a filter element disposed within the hollow filter body;
a filter element cover configured to cover and secure the filter element, said filter element cover including depressions in an outer peripheral edge,
wherein the depressions in the outer peripheral edge form openings between the depressions and an inner peripheral surface of the filter body, such that water can flow into the openings, through the filter element, and out of the filter body through the fluid egress orifice.

2. The replacement filter cartridge of claim 1, wherein the filter body has a cylindrical shape, and wherein outer sides of the filter body are smooth.

3. The replacement filter cartridge of claim 1, wherein the castellations are configured to engage a tab on an inner upper surface of a water filter housing.

4. The replacement filter cartridge of claim 1, wherein a lower outer surface of the bottom portion of the filter body includes a plurality of radial ribs.

5. The replacement filter cartridge of claim 4, wherein the lower outer surface includes a single extended structural ring surrounding the water egress orifice, and a shortened structural ring.

6. The replacement filter cartridge of claim 1, further comprising a wrap surrounding the filter element.

7. The replacement filter cartridge of claim 1, wherein the filter element comprises a carbon block.

8. The replacement filter of claim 6, wherein the wrap comprises a fabric sleeve.

9. The replacement filter cartridge of claim 5, wherein the shortened structural ring surrounds the extended structural ring.
